(19) United States
(12) Patent Application Publication
(10) Pub. No.: US 2019/0034397 A1
(43) Pub. Date: Jan. 31, 2019

(54) NON-TRANSITORY COMPUTER-READABLE STORAGE MEDIUM, DETERMINATION METHOD, AND DETERMINATION APPARATUS

(71) Applicant: FUJITSU LIMITED, Kawasaki-shi (JP)

(72) Inventor: Naoto Hiramatsu, Shizuoka (JP)

(73) Assignee: FUJITSU LIMITED, Kawasaki-shi (JP)

(21) Appl. No.: 16/046,743

(22) Filed: Jul. 26, 2018

(30) Foreign Application Priority Data
Jul. 31, 2017 (JP) 2017-147407

(51) Int. Cl. G06F 17/24; G06K 9/00

(52) U.S. Cl. CPC G06F 17/242; G06K 9/00409

(57) ABSTRACT

A non-transitory computer-readable storage medium storing a program that causes a computer to execute a process, the process including receiving an input of locus data of handwriting, determining whether at least one of a velocity and acceleration at a position forward or rearward from a turned-back position in a direction of the handwriting in a locus indicated by the locus data satisfies a first criterion based on the input locus data, and determining whether the received input is a deletion instruction based on whether the first criterion is satisfied.

### CROSS-REFERENCE TO RELATED APPLICATION

This application is based upon and claims the benefit of priority of the prior Japanese Patent Application No. 2017-147407, filed on Jul. 31, 2017, the entire contents of which are incorporated herein by reference.

### FIELD

The embodiment discussed herein is related to a non-transitory computer-readable storage medium, a determination method, and a determination apparatus.

### BACKGROUND

A smart device such as a tablet terminal receives a handwritten input to a touch screen display, for example. The smart device changes contents displayed on the touch screen display based on an operation of the input.

One example of the operation of the input is an operation of deleting information displayed on the touch screen display (deletion instruction). When receiving a handwritten input of the deletion instruction, the smart device performs control to delete information displayed on the touch screen display. As related techniques, Japanese Laid-open Patent Publication Nos. 7-13686, 2-113386, 2012-27778, and 2014-16668 are proposed.

A technique is proposed that determines that an instruction of deletion is issued, when a direction of an eraser stroke with a stylus pen of an eraser function is changed with respect to the first stroke, or when the eraser stroke in a predetermined direction is made a predetermined number of times of instructions.

Another technique is proposed that when a stroke with a length of a predetermined threshold or greater is written during character input, regards the stroke as character deletion, and deletes a character relevant to the character deletion instruction.

Still another technique is proposed that recognizes a character written on a plane smoothly and reliably based on a measurement result of an acceleration sensor. Moreover, a technique is proposed that is allowed to facilitate an instruction operation for a deletion area and deletes a handwriting character reliably, while maintaining flexibility of a handwritten input position.

### SUMMARY

According to an aspect of the invention, a non-transitory computer-readable storage medium storing a program that causes a computer to execute a process, the process including receiving an input of locus data of handwriting, determining whether at least one of a velocity and acceleration at a position forward or rearward from a turned-back position in a direction of the handwriting in a locus indicated by the locus data satisfies a first criterion based on the input locus data, and determining whether the received input is a deletion instruction based on whether the first criterion is satisfied.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a smart device in an embodiment;

FIG. 2 is a diagram illustrating a screen example (part 1);

FIG. 3 is a diagram illustrating an example of a handwritten change of characters (part 1);

FIG. 4 is a diagram illustrating an example of a handwritten change of a character (part 2);

FIG. 5 is a diagram illustrating an example of a handwritten change of characters (part 3);

FIG. 6 is a diagram illustrating an example of vectors of locus data;

FIG. 7 is a diagram illustrating an example of locus data of handwriting;

FIG. 8 is a diagram illustrating an example of determination of a deletion instruction (part 1);

FIG. 9 is a diagram illustrating an example of determination of a deletion instruction (part 2);

FIG. 10 is a diagram illustrating an example of determination of the deletion instruction (part 3);

FIGS. 11A and 11B are diagrams illustrating examples of a relation between time and a variation;

FIG. 12 is a diagram illustrating an example of a handwritten change of the characters (part 4);

FIG. 13 is a flowchart (part 1) illustrating an example of a process flow in the embodiment;

FIG. 14 is a flowchart (part 2) illustrating an example of a process flow in the embodiment;

FIG. 15 is a flowchart (part 3) illustrating an example of a process flow in the embodiment;

FIG. 16 is a diagram illustrating are example of changes in density in a modified example 1;

FIG. 17 is a flowchart illustrating an example of a process flow in the modified example 1;

FIG. 18 is a flowchart illustrating an example of a process flow in a modified example 2;

FIG. 19 is diagram illustrating an example of changes in density in a modified example 3;

FIG. 20 is a flowchart illustrating an example of a process flow in the modified example 2; and

FIG. 21 is a diagram illustrating an example of a hardware configuration of a determination apparatus.

### DESCRIPTION OF EMBODIMENT

When an operator operating a smart device deletes information displayed on a screen of the smart device by a handwritten deletion instruction, the handwriting may be shaky, for example. If the shaky handwriting and the like are applied to the deletion instruction, the smart device may determine that the input operation for the deletion instruction is an input of a character, a symbol, or the like instead of the deletion instruction.

In one aspect, an aim is to improve determination accuracy of the deletion instruction.

<Example of Smart Device>

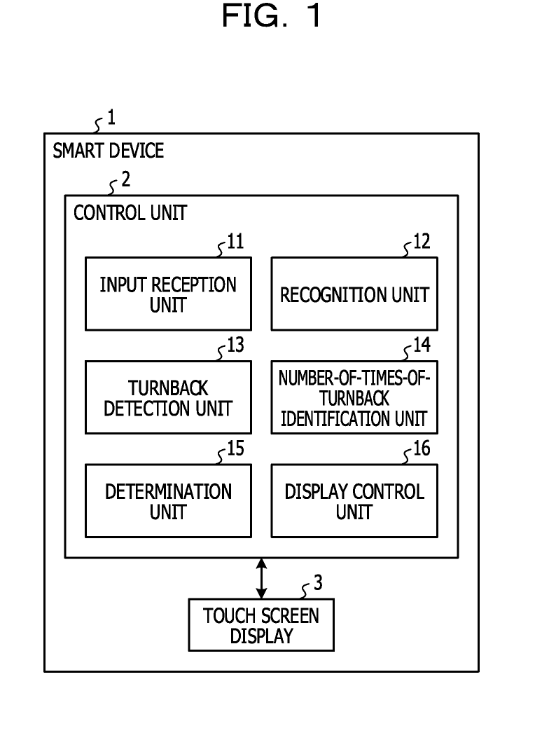

An embodiment will be described below with reference to the drawings. FIG. 1 is a diagram illustrating an example of a smart device 1. The smart device 1 is an example of a computer or a determination apparatus. Examples of the smart device 1 include a tablet terminal and a smartphone. This embodiment may be applied to a computer other than the smart device.

The smart device 1 includes a control unit 2 and a touch screen display 3. The control unit 2 performs various types of controls in the smart device 1. The touch screen display 3 has a display function and an input function. The touch screen display 3 is an example of a display unit.

The control unit 2 includes an input reception unit 11, a recognition unit 12, a turnback detection unit 13, a number-of-times-of-turnback identification unit 14, a determination unit 15, and a display control unit 16. The input reception unit 11 receives a handwritten input to the touch screen display 3.

An operator operating the smart device 1 slides the touch screen display 3 while touching (pressing) the touch screen display 3 with a finger, a dedicated pen, or the like, and then the touch screen display 3 detects a locus corresponding to the sliding operation as locus data. The locus data contains a character, a graphic, a symbol, or a deletion instruction, for example.

The locus data indicates a locus of points (point sequence) detected by the touch screen display 3. The first point of the point sequence in the locus data is a point that is pressed first on the touch screen display 3. The last point thereof is a point when the pressing on the touch screen display 3 is not detected any more. Each point in the locus data is detected every certain time interval.

The handwritten input may be an input made using a mouse connected to the computer, for example. The locus data of the input handwritten with a mouse indicates a locus created during the period from start of a mouse click to release of the mouse click.

The recognition unit 12 recognizes the input received by the input reception unit 11. The recognition unit 12 receives an input of a handwritten character and recognizes the handwritten character, for example. When receiving an input of a handwritten symbol, the recognition unit 12 recognizes the handwritten symbol.

The turnback detection unit 13 detects a turnback of a handwritten input. For example, a reversed position where the direction of a handwritten input is reversed may be a turned-back position. The turnback detection unit 13 detects a turnback based on a velocity or acceleration at a position forward or rearward from the turned-back position in a direction of handwriting.

In the following description, the turnback detection unit 13 is assumed to detect turnbacks based on deceleration at a point immediately before the turned-back position and acceleration at a point immediately behind the turned-back position, in the direction of handwriting. The deceleration is acceleration in the negative direction.

The turnback detection unit 13 may detect a turnback based on any of the deceleration at the point immediately before the turned-back position and the acceleration at the point immediately behind the turned-back position, in the direction of handwriting. The turnback detection unit 13 may detect a turnback based on any of a velocity at the point immediately before the turned-back position and a velocity at the point immediately behind the turned-back position, in the direction of handwriting.

A point on the touch screen display 3 is represented by coordinates in an X direction and a Y direction of two orthogonal axes. The turnback detection unit 13 detects a turnback based on the deceleration at the point immediately before the turned-back position and the acceleration at the point immediately behind the turned-back position, in the direction of handwriting, for each of the X direction and the Y direction.

The number-of-times-of-turnback identification unit 14 identifies the number of times of turnbacks detected by the turnback detection unit 13. The number-of-times-of-turnback identification unit 14 increments the number of times of turnbacks by 1 each time the turnback detection unit 13 detects a turnback. An initial value of the number of times of turnbacks is zero.

The determination unit 15 determines whether the number of times of turnbacks (the number of turned-back positions) is greater than a predetermined number. The determination unit 15 determines that if the number of times of turnbacks is greater than the predetermined number, a second criterion is satisfied.

This turnback is detected by the turnback detection unit 13. The turnback detection unit 13 detects a turnback if the deceleration at the point immediately before the turned-back position is a deceleration threshold or greater and the acceleration at the point immediately behind the turned-back position is an acceleration threshold or greater, in the direction of handwriting.

The determination unit 15 therefore determines whether the number of times of turnbacks is greater than the predetermined number, when the turnback is made at the deceleration and the acceleration that satisfy the above-described condition (first criterion), the deceleration being at the point immediately before the turned-back position and the acceleration being at the point immediately behind the turned-back position, in the direction of handwriting. If the number of times of turnbacks is greater than the predetermined number, the determination unit 15 determines that a determination result is affirmative and thus the locus data is a deletion instruction.

The display control unit 16 performs a display control on the touch screen display 3. The touch screen display 3 performs display based on the display control by the display control unit 16.

<Example of Handwritten Changes of Character>

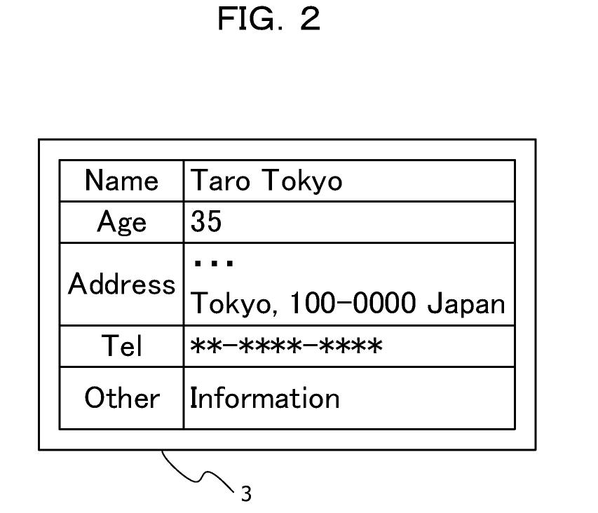

FIG. 2 illustrates a screen example displayed on the touch screen display 3. The screen example illustrated in FIG. 2 is an example of an order slip data. In the screen example, information (display information) is displayed in each item of “Name”, “Age”, “Address”, “Tel”, and “Other”.

The display information depicted in FIG. 2 is information that the display control unit 16 causes the touch screen display 3 to display. This information is not handwritten information but handwritten information such as a character, a graphic, and a symbol may be input to the touch screen display 3, as described above.

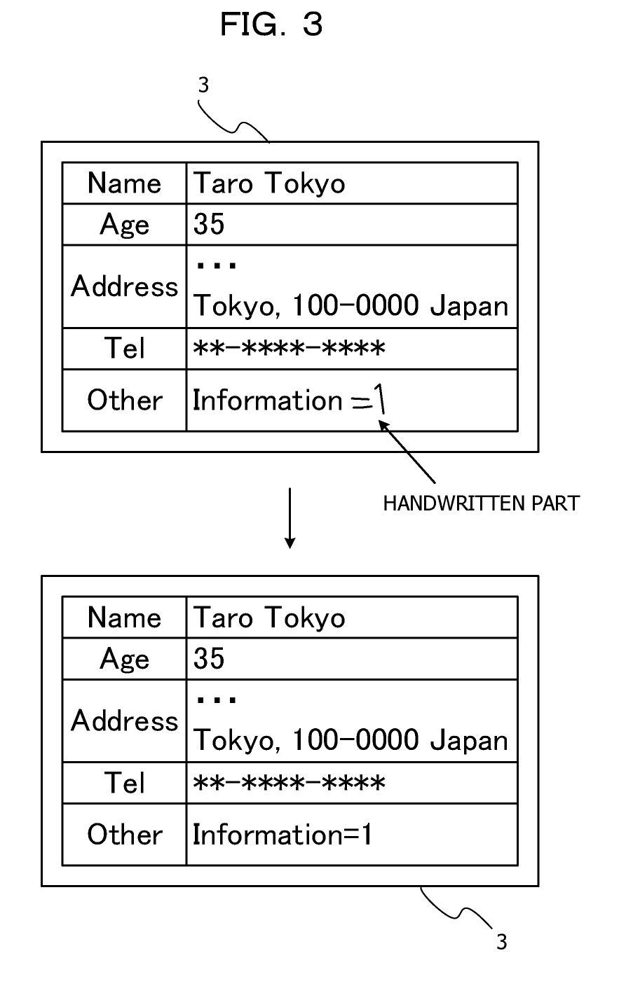

FIG. 3 is a diagram illustrating an example in which “=1” written by hand is input to display information of “Information” in the screen example of FIG. 2. Assume that an operator inputs “=1” by handwriting to the touch screen display 3. The input reception unit 11 receives the input.

“=1” contains three pieces of locus data. That is, “=” contains two lines of locus data and “1” contains one line of locus data. The recognition unit 12 recognizes a symbol of “=” and the character of “1”.

The display control unit 16 performs a control to display “=1” recognized by the recognition unit 12 on the touch screen display 3 as the display information. Based on this control, “=1” is displayed on the touch screen display 3 as the display information.

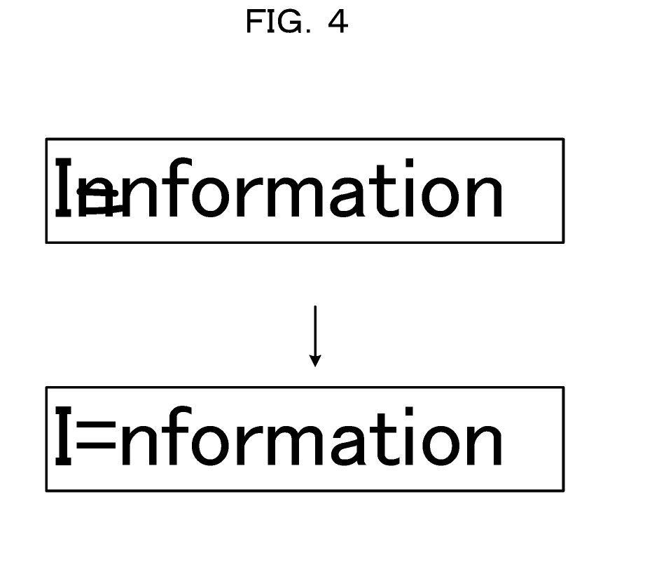

FIG. 4 illustrates an example of handwritten deletion of a display character. In the embodiment, a display character is deleted by inputting a certain deletion instruction over the display character instead of using an eraser function. Note that, however, the display character may be deleted by using an eraser function or other function in addition to the deletion instruction.

An operator inputs a deletion instruction above the display character, and then the input reception unit 11 receives the input. The deletion instruction in the example of FIG. 4 is a double line, so that the input reception unit 11 receives an input of the double line.

The double line is similar to the symbol “=” in shape. The recognition unit 12 may therefore recognize the input (double line) received by the input reception unit 11 as an input of the symbol “=”. At this time, the display control unit 16 performs a control to replace the display information “n” with the symbol “=” for display.

In the example of FIG. 4, “n” of the display character “Innformation” is replaced with the symbol “=”, so that “I=formation” is displayed on the touch screen display 3.

The same applies to a case of a deletion instruction of one straight line. The recognition unit 12 may recognize one straight line as a subtraction symbol of “−”. The display control unit 16 then replaces “n” with the subtraction symbol “−” for display. Therefore, “I−formation” is displayed on the touch screen display 3.

One straight line and a double line are highly likely to be recognized as a different symbol from the deletion instruction by the recognition unit 12. On the other hand, in a case of an input of a deletion instruction by scribbling out a display character, the recognition unit 12 recognizes the input of the scribbled-out display character as a character to be deleted more easily than the input of one straight line or a double line.

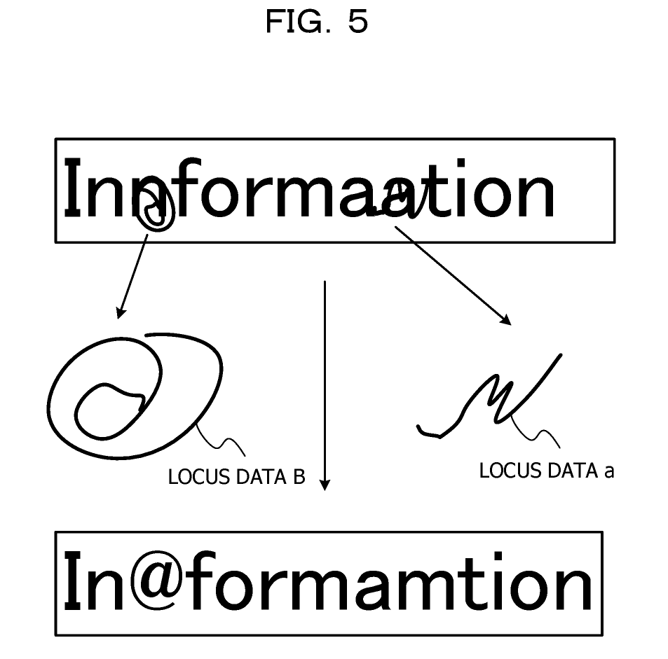

FIG. 5 illustrates locus data A and locus data B each of which is an example of a deletion instruction. The locus data A is a deletion instruction input over a display character “a” and provides a locus in which the display character “a” is scribbled out. The deletion instruction of the locus data A is a linear deletion instruction involving multiple turnbacks.

The locus data B is a deletion instruction input over the display character “n” and provides a locus in which the display character “n” is scribbled out. The deletion instruction of the locus data B is a circular deletion instruction involving multiple turnbacks.

The locus data A and the locus data B are the deletion instructions involving multiple turnbacks. These deletion instructions are likely to be recognized as an instruction to delete a display character, as compared with the cases of a simple one line and a double line. Input operations such as scribbling out the display character (input operation involving multiple turnbacks) are similar to friction, which is intuitive and easy for an operator to recognize such operation as the operation of deleting the display character.

However, both the locus data A and the locus data B are in some cases recognized as a character and a symbol. In the example of FIG. 5, for example, the recognition unit 12 may respectively recognize the locus data A and the locus data B as a character “m” and a symbol “@”.

The locus data A is a linear locus containing multiple turnbacks, and the character “m” is also a linear character containing multiple turnbacks. The similarity between the locus data A and the character “m” in shape may cause the recognition unit 12 to recognize the locus data A as the character “m”.

The locus data B is a circular locus containing multiple turnbacks, and the symbol “@” is also a curved character containing multiple turnbacks. The similarity between the locus data B and the symbol “@” in shape may cause the recognition unit 12 to recognize the locus data B as the symbol “@”.

Even when an operator has an intention of a deletion instruction and inputs the locus of the locus data A or the locus of the locus data B to the touch screen display 3, the recognition unit 12 possibly recognizes the locus data A as the character “m” or the locus data B as the symbol “@”.

The recognition by the recognition unit 12 as described above causes the display character “n” and the display character “a” to be replaced respectively with the symbol “@” and the character “m”, and thus “In@formation” is displayed on the touch screen display 3, as illustrated in the example of FIG. 5.

With low determination accuracy of the deletion instruction input to the touch screen display 3 in this way, information with a result different from an operation intentionally input by an operator (deletion instruction) may be displayed on the touch screen display 3.

<Example of Turnbacks in Locus Data>

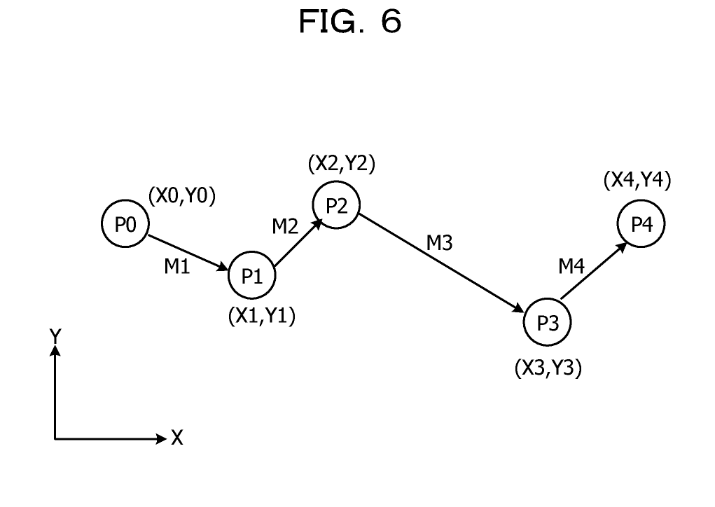

Referring to FIG. 6, an example of vectors of the locus data will be described. The example of FIG. 6 illustrates an example of vectors converted from the locus data displayed on the touch screen display 3. The locus data contains points detected every certain time interval. In the example of FIG. 6, a point Pk (k is an integer of zero or greater) indicates a point that is detected as a k-th point.

Points P0 to P4 are depicted in FIG. 6, where the point Pk is represented as “Pk=(Xk,Yk)” in the X-Y coordinate system of the touch screen display 3. In the example of FIG. 6, M1 to M4 each indicate a vector. The vector M1 indicates a vector linked between the point P0 and the point P1, and the vector M2 indicates a vector linked between the point P1 and the point P2, for example.

As seen from the example of FIG. 6, the directions of the vectors M1 and M2 are changed oppositely in the direction. Therefore, the point P1 is likely to be a turned-back position. Likewise, the directions of the vectors of the points P2 and P3 are changed oppositely in the direction. Therefore, the point P2 and the point P3 are likely to be turned-back positions.

The vectors decomposed into components in each of the X direction and the direction of two orthogonal axes are represented as M(kx) in the X direction and M(ky) in the Y direction, as follows.

M(kx)=X(k)−X(k−1)

M(ky)=Y(k)−Y(k−1)

Here, k is an integer of zero or greater. Note, that X(k) and Y(k) are examples of a first point and X(k−1) and Y(k−1) are examples of a second point.

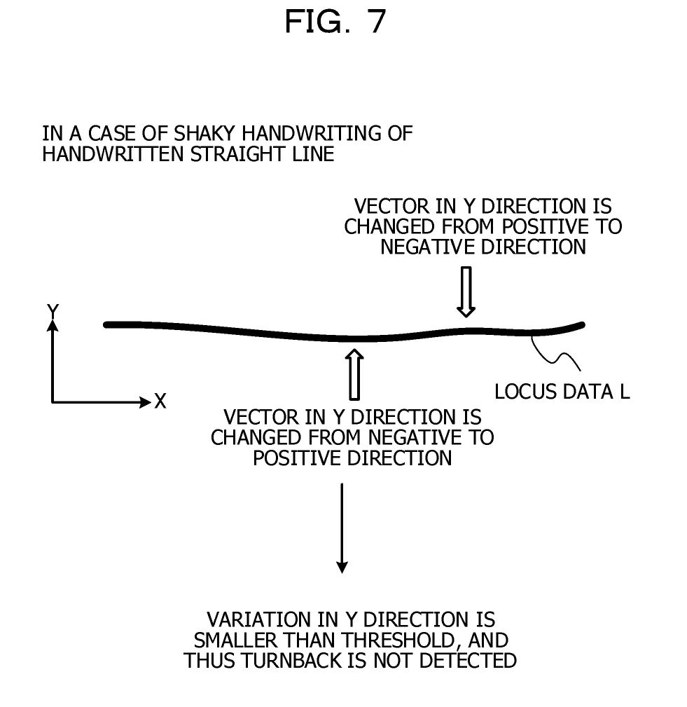

FIG. 7 illustrates an example of locus data L of handwriting. Assume that an operator inputs a handwritten straight line to the touch screen display 3. The straight line input to the touch screen display 3 by the operator is in some cases slightly distorted due to shaky handwriting and the like. In this case, a straight line containing distortion components is input to the touch screen display 3. The input reception unit 11 receives this input.

At the distorted sections of the line, the directions of vectors in the Y direction are changed from the negative to positive direction or from the positive to negative direction. The distorted sections are a section where the vector direction is changed not due to the turned-back position of the deletion instruction but due to shaky handwriting and the like.

In the embodiment, a threshold ε is used for the turnback detection unit 13 not to detect the section with the vector direction changed due to shaky handwriting and the like as a turned-back position of the deletion instruction. The threshold ε is an example of a variation threshold.

The turnback detection unit 13 does not detect a turnback having a point with a vector direction changed in the locus data when the vector direction is not largely changed. Thus, the vector direction changed due to shaky handwriting and the like is not detected as a turnback.

When a variation in the X direction between two continuous points of the locus data exceeds a threshold ε(X), the turnback detection unit 13 detects that the vector direction is largely changed in the X direction. When a variation in the Y direction between two continuous points of the locus data exceeds a threshold ε(Y), the turnback detection unit 13 detects that the vector direction is largely changed in the Y direction.

The threshold ε(X) is the threshold ε in variation in the X direction, and the threshold ε(Y) is the threshold ε in variation in the direction. Any value may be set to the threshold ε(X) and the threshold ε(Y).

The turnback detection unit 13 detects whether the variation in the X direction or the Y direction between the two continuous points is large based on the following (A) to (D).

(A) If “X(k)−X(k−1)>ε(X)” is satisfied, the turnback detection unit 13 detects that the variation in the positive X direction is large.

(B) If “−(X(k)−X(k−1))>ε(X)” is satisfied, the turnback detection unit 13 detects that the variation in the negative X direction is large.

(C) If “Y(k)−Y(k−1)>ε(Y)” is satisfied, the turnback detection unit 13 detects that the variation in the positive Y direction is large.

(D) If “−(Y(k)−Y(k−1))>ε(Y)” is satisfied, the turnback detection unit 13 detects that the variation in the negative Y direction is large.

The sections with distortion occurring on the line in the example of FIG. 7 satisfy none of these four conditions. That is, the variation between the two points at the distorted section of the line is small.

Therefore, the turnback detection unit 13 does not detect, as a turned-back position, the distorted section of the line with the vector direction changed oppositely if the variation between the two points is small. This avoids detecting a distortion of the line due to shaky handwriting and the like as a turnback.

The turnback detection unit 13 detects a point with the vector direction changed oppositely and a large variation. In the embodiment, the turnback detection unit 13 uses two variables of D(kx) and D(ky) to detect a point with the vector direction changed oppositely and a large variation.

The variables D(kx) and D(ky) are set to “Undefined” as an initial value. The variables D(kx) and D(ky) are then set to any of “True” and “False” by the turn back detection unit 13.

The turnback detection unit 13, with regard to the two continuous points, sets the variable D(kx) to “True” when determining that the condition (A) is satisfied. The turnback detection unit 13, with regard to the two continuous points, sets the variable D(kx) to “False” when determining that the condition (B) is satisfied.

The turnback detection unit 13, with regard to the two continuous points, sets the variable D(ky) to “True” when determining that the condition (C) is satisfied. The turnback detection unit 13, with regard to the two continuous points, sets the variable D(ky) to “False” when determining that the condition (D) is satisfied.

When setting values to the variable D(k) and the variable D(ky) for the k-th point, the turnback detection unit 13 recognizes the variable D((k−1)x) and the variable D((k−1)y) for the (k−1)-th point.

When the variable D(kx) and the variable D((k−1)x) have a different value, the turnback detection unit 13 detects that the vector direction is changed oppositely in the X direction and the variation is large. When the variable D(kx) and the variable D((k−1)x) have the same value, the turnback detection unit 13 detects that no change in the X direction occurs in the vector direction.

When the variable D(ky) and the variable D((k−1)y) have a different value, the turnback detection unit 13 detects that the vector direction is changed oppositely in the Y direction and the variation is large. When the variable D(ky) and the variable D((k−1)y) have the same value, the turnback detection unit 1 detects that no change in the direction occurs in the vector direction.

The turnback detection unit 13 may therefore detect a point with the vector direction changed oppositely and a large variation in the locus data. Methods for detecting the point with the vector direction changed oppositely and a large variation in the locus data are not limited to the method using the values of the variable D(kx) and the variable D((k−1)x).

Even if a point with the vector direction changed oppositely and a large variation is detected, the point may not be a turned-back position intended by an operator. For example, the point with the vector direction changed oppositely and a large variation may be detected when handwriting shakes considerably in inputting a deletion instruction to the touch screen display 3 by an operator.

A deletion instruction involving an intended turnback will now be described. When the deceleration rearward from the turned-back position in the direction of handwriting is large (deceleration threshold or greater), an operator is supposed to intend to turn back a handwritten line.

When the acceleration forward from the turned-back position in the direction of handwriting is large (acceleration threshold or greater), an operator is supposed to intend to turn back a handwritten line. That is, when an operator intends to turn back a handwritten line, the deceleration immediately before the turned-back position increases, the velocity reaches zero at the turned-back position, and the acceleration immediately behind the turned-back position increases.

The turnback detection unit 13 determines the velocity and the acceleration forward and rearward from the turned-back position in the direction of handwriting, based on the coordinates of two continuous points and a certain time interval (unit time) at which the points contained in the locus data are detected.

The velocity v(t) and the acceleration a(t) are obtained by the following expressions, where the unit time is dt.

v(t)=(Pt−P(t−1))/dt

a(t)=(v(t)−v(t−1))/dt

Assume that the turnback detection unit 13 detects that the deceleration at the point P(k−1) is the deceleration threshold or greater and the acceleration at the point P(k+1) is the acceleration threshold or greater. The point P(k−1) is a point immediately before (rearward from) the point P(k) in the direction of handwriting, and the point P(k+1) is a point immediately behind (forward from) the point P(k) in the direction of handwriting. In this case, the turnback detection unit 13 detects that the point P(k) is a turned-back position.

When the deceleration forward from the turned-back position and the acceleration rearward from the turned-back position, in the direction of handwriting, are large, an operator intends to turn back a handwritten line with a high possibility. This fact contributes to improvement in accuracy of detecting the turned-back position.

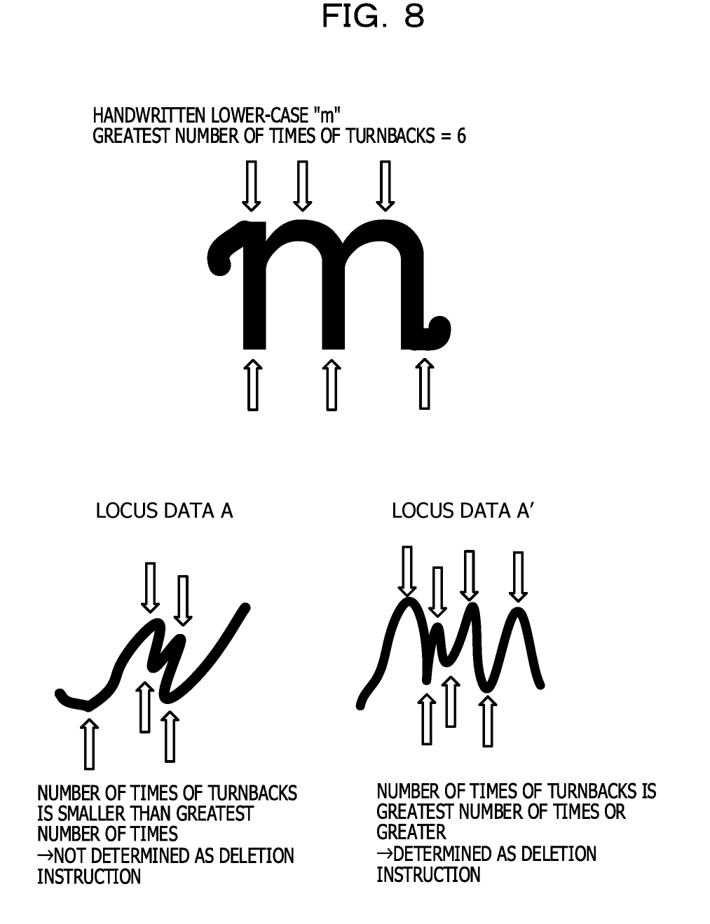

Referring to FIGS. 8 to 10, examples of determination of deletion instructions will now be described. The example of FIG. 8 illustrates a handwritten lower-case “m” input to the touch screen display 3.

Of the alphabets, the alphabet with the greatest number of times of turnbacks (number of turned-back positions) is the lower-case “m” or upper-case “M”, which has the number of times of turnbacks of “4”. Meanwhile, in the case of a handwritten character input, a “hook” may be attached to the input character.

In the example of FIG. 8, a “hook” is attached to the first and last strokes of the lower-case “m”. The greatest number of times of turnbacks among the alphabets containing the turnback of the “hook” is “6=4+2”. The greatest number of times of turnbacks among the alphabets without containing the turnback of the “hook” is “4”.

The locus data A is locus data input to the touch screen display 3 by an operator intending the deletion instruction. The locus data A is similar to the lower-case “m” of the alphabet in shape.

The number-of-times-of-turnback identification unit 14 increments the number of times of turnbacks by 1 each time the turnback detection unit 13 detects a turnback. In the example of FIG. 8, the number of times of turnbacks identified by the number-of-times-of-turnback identification unit 14 is “5”, which is smaller than the above-described greatest number of times. The locus data A may therefore be recognized as the lower-case “m”.

Meanwhile, locus data A′ is also locus data input to the touch screen display 3 by an operator intending the deletion instruction. The number of times of turnbacks of the locus data A′ identified by the number-of-times-of-turnback identification unit 14 is “7”, which is greater than the greatest number of times.

If the number of times of turnbacks in the locus corresponding to the locus data is greater than the greatest number of times, the determination unit 15 determines that the locus data is a deletion instruction. The greatest number of times is an example of the predetermined number.

The locus data A′ has the number of times of turnbacks of “7”, and thus the determination unit 15 determines that the locus data A′ is a deletion instruction. No character has the number of times of turnbacks of the locus data greater than the greatest number of times, and therefore recognition of the locus data as a character is suppressed. The determination unit 15 accordingly determines whether the locus data is a deletion instruction based on the above-described condition.

The turnback is a turnback detected by the turnback detection unit 13 based on the deceleration forward from the turned-back position and the acceleration rearward from the turned-back position, in the direction of handwriting. The determination unit 15 determines whether the number of times of turnbacks detected based on the deceleration and the acceleration is the greatest number of times or greater. If the determination result is affirmative (the number of times of turnbacks is greater than the greatest number of times), the determination unit 15 determines that the locus data A′ is a deletion instruction.

Of the alphabets, the character with the greatest number of times of turnbacks is the lower-case “m” or upper-case “M”. The character with the greatest number of times of turnbacks of the Greek characters is “ξ”, for example. The greatest number of times in the case of the character type of the Greek character may be defined based on the number of times of turnbacks of “ξ” (=6).

The greatest number of times is set to a value greater than the greatest number of times of turnbacks of a character among multiple characters belonging to a character type recognizable by the smart device 1. For example, when the character type is the alphabets, the greatest number of times of turnbacks is “4”, whereas when the character type is the Greek characters, the greatest number of times of turnbacks is “6”.

The greatest numbers of times of turnbacks containing the above-described “hook” among the alphabets and the Greek characters are “6” and “8”, respectively.

When the smart device 1 is capable of recognizing the multiple character types, the number of times of turnbacks of a character with the greatest number of times of turnbacks may be set to the greatest number of times (predetermined number), among the characters belonging to each character type.

When the smart device 1 is capable of recognizing the alphabets and the Greek characters, the greatest number of times containing the above-described “hook” is set to “8”.

The number of times of turnbacks of the locus data is a factor to determine whether the locus data is a deletion instruction, and therefore, the number of times of turnbacks of the locus data is preferably detected with high accuracy.

As has been described above, the turnback detection unit 13 does not detect a turned-back position of the locus data when the variation in the X direction or the Y direction is small (variation is ε or smaller). The turnback detection unit 13 then detects a turned-back position of the locus data based on the handwriting deceleration forward from the turned-back position or the handwriting acceleration rearward from the turned-back position, in the direction of handwriting.

The turnback detection unit 13 may therefore detect that the turnback of the locus data input to the touch screen display 3 is a turnback intended by an operator, and thus the accuracy of detecting the turnback of the locus data is improved. This improvement in turnback detection accuracy improves the determination accuracy of the deletion instruction.

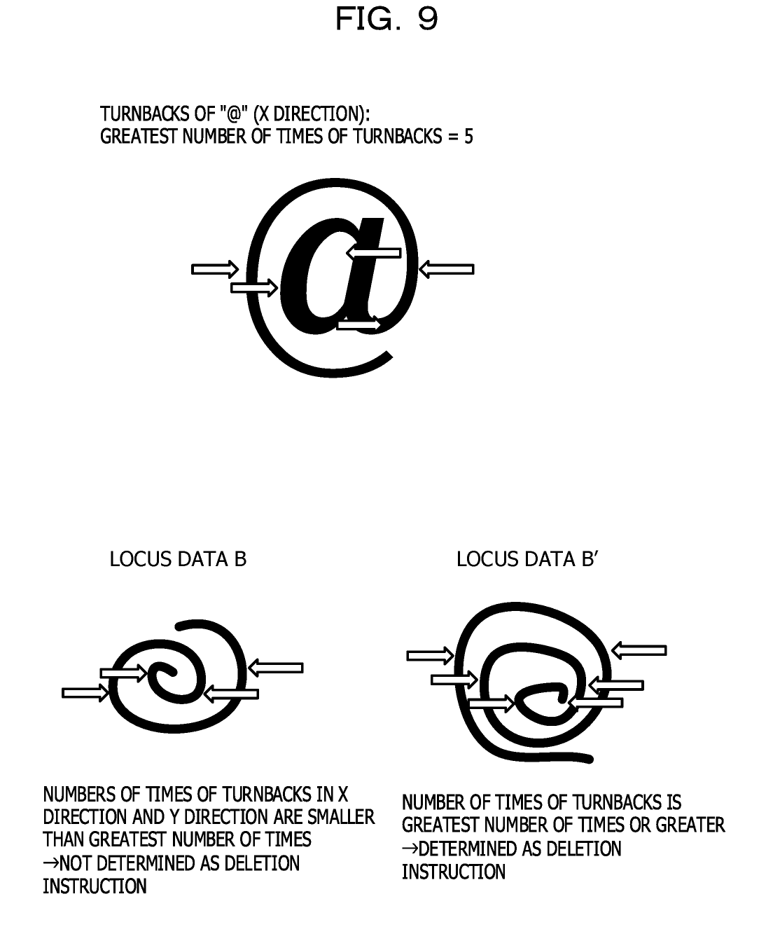

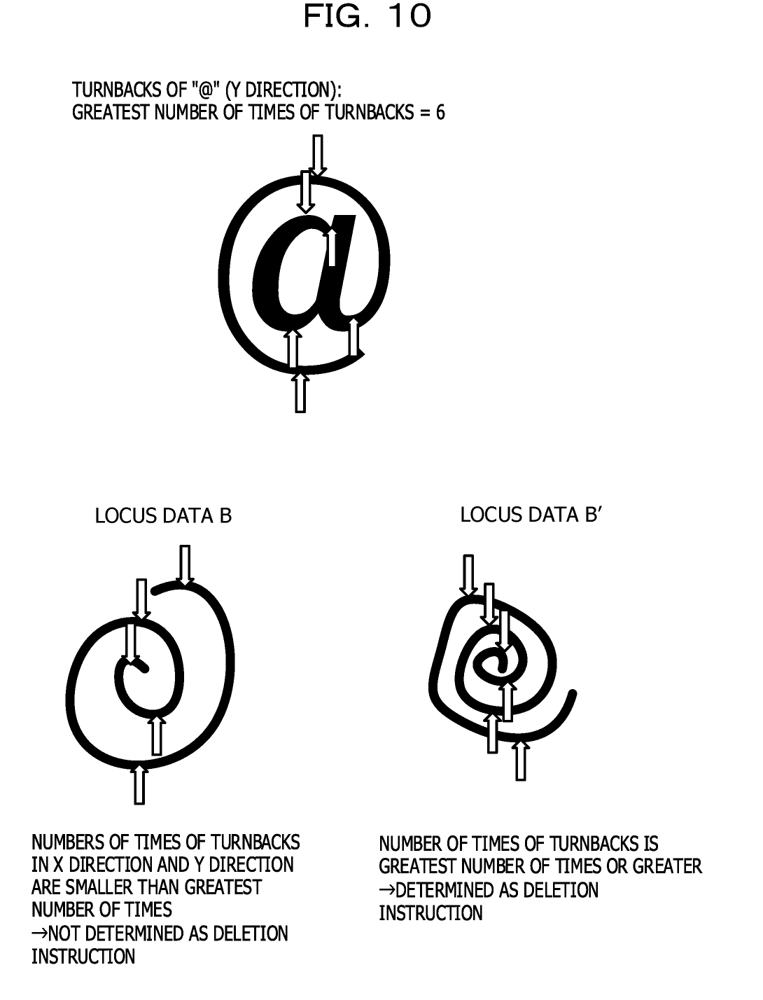

FIGS. 9 and 10 are diagrams illustrating examples of the symbol “@” and the circular locus data. The circular locus data decomposed into components in the X direction and the Y direction may be represented with a sine wave, for example.

The example of FIG. 9 is an example illustrating a turned-back position in the X direction, and the example of FIG. 10 is an example illustrating a turned-back position in the direction. The symbol with the greatest number of times of turnbacks is assumed to be “@” among the multiple symbols recognizable by the smart device 1.

The symbol “@” has the greatest number of times of turnbacks in the X direction of “5”, as illustrated in the example of FIG. 9. The symbol “@” is similar to the locus data B in shape, and the locus data B has the number of times of turnbacks of “4”. Meanwhile, locus data B′ has the number of times of turnbacks of “6”, which is greater than the greatest number of times. The determination unit 15 accordingly determines that the locus data B′ is a deletion instruction.

As illustrated in the example of FIG. 10, the symbol “@” has the greatest number of times of turnbacks in the Y direction of “5”. The symbol “@” and the locus data B are similar in shape, and the number of times of turnbacks of the locus data B is “5”.

If the number of times of turnbacks in the X direction is the greatest number of times or smaller in the X direction, and the number of times of turnbacks in the Y direction is the greatest number of times or smaller in the Y direction, the determination unit 15 does not determine that the locus data is a deletion instruction.

In the examples of FIGS. 9 and 10, the locus data B satisfies these conditions, and therefore the determination unit 15 does not determine that the locus data B is a deletion instruction.

If the number of times of turnbacks in the X direction of the locus data is greater than the greatest number of times in the X direction, or the number of times of turnbacks in the direction is greater than the greatest number of times in the Y direction, the determination unit 15 determines that the locus data is a deletion instruction.

In the examples of FIGS. 9 and 10, the locus data B′ satisfies these conditions, and therefore the determination unit 15 determines that the locus data B′ is a deletion instruction.

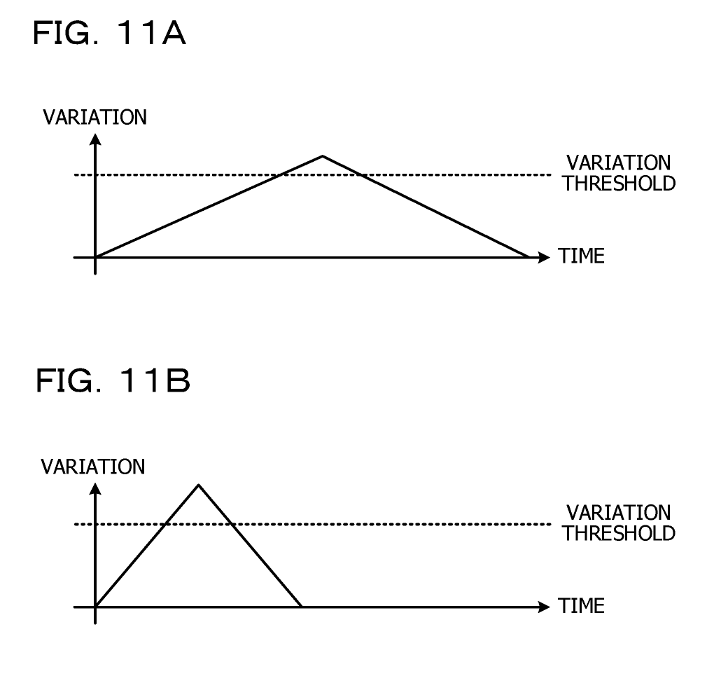

The turnback detection unit 13 does not detect a turned-back position with the changed direction of the vector between the two continuous points if the variation is smaller than the threshold ε, as described above. FIG. 11A is a diagram illustrating an example of a relation between time and the variation when handwriting shakes considerably. The variation denotes a variation between two continuous points.

The variation in the example of FIG. 11A exceeds the variation threshold (threshold ε). When handwriting shakes considerably, the locus data input to the touch screen display 3 may not be a deletion instruction input intended by an operator.

The determination unit 15 determines whether the locus data is a deletion instruction based on the deceleration at the position forward from the turned-back position and the handwriting acceleration rearward from the turned-back position, in the direction of handwriting. A graph of an example of FIG. 11B indicates a large variation with respect to the time (rate of change).

When the deceleration at the position rearward from the turned-back position of the locus data is large, the turned-back position is supposed to be a turned-back position intended by an operator. When the acceleration at the position forward from the turned-back position of the locus data is large, the turned-back position is supposed to be a turned-back position intended by an operator.

The turnback detection unit 13 detects the turned-back position based on the deceleration or the acceleration as well as the variation between the two continuous points, which improves the accuracy of determining, by the determination unit 15, whether the detected turned-back position is a turned-back position intended by an operator.

The number-of-times-of-turnback identification unit 14 increments the number of times of turnbacks by 1 each time the turnback detection unit 13 detects a turnback. The determination unit 15 determines whether the locus data is a deletion instruction based on the number of times of turnbacks identified by the number-of-times-of-turnback identification unit 14. This improves the accuracy of determining the turned-back position, which also improves the accuracy of determining whether the locus data is a deletion instruction.

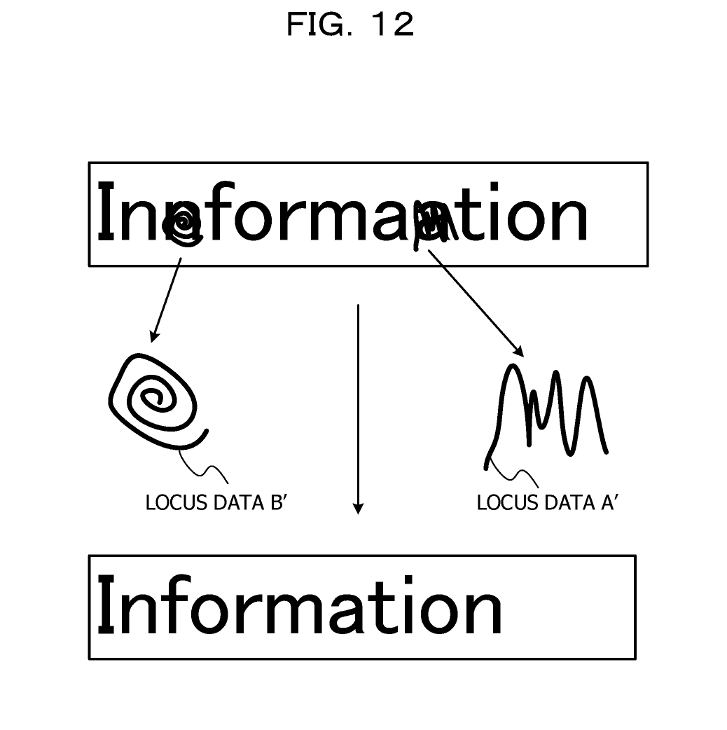

FIG. 12 illustrates an example of changes of the characters in the locus data A′ and the locus data B′ input to the touch screen display 3. As described above, the determination unit 15 determines that the locus data A′ and the locus data B′ are deletion instructions.

The display control unit 16 deletes the display character “n” based on the deletion instruction overlaid on the display character “n”, and deletes the display character “a” based on the deletion instruction overlaid on the display character “a”. The deletions by the display control unit 16 result in displaying the display characters “Information” on the touch screen display 3.

The case where the locus data is determined as a deletion instruction when the turnback is detected multiple times is described in the above examples. Alternatively, locus data with a turnback detected once may be determined as a deletion instruction.

In this case, the locus data is determined as a deletion instruction in response to at least the detection that the deceleration is the deceleration threshold or greater or the detection that the acceleration is the acceleration threshold or greater. The deceleration is deceleration at the position forward from the turned-back position and the acceleration is acceleration at the position rearward from the turned-back position, in the direction of handwriting of the locus corresponding to the locus data. The same applies to the velocity.

### Flowchart Illustrating Example of Process Flow in Embodiment

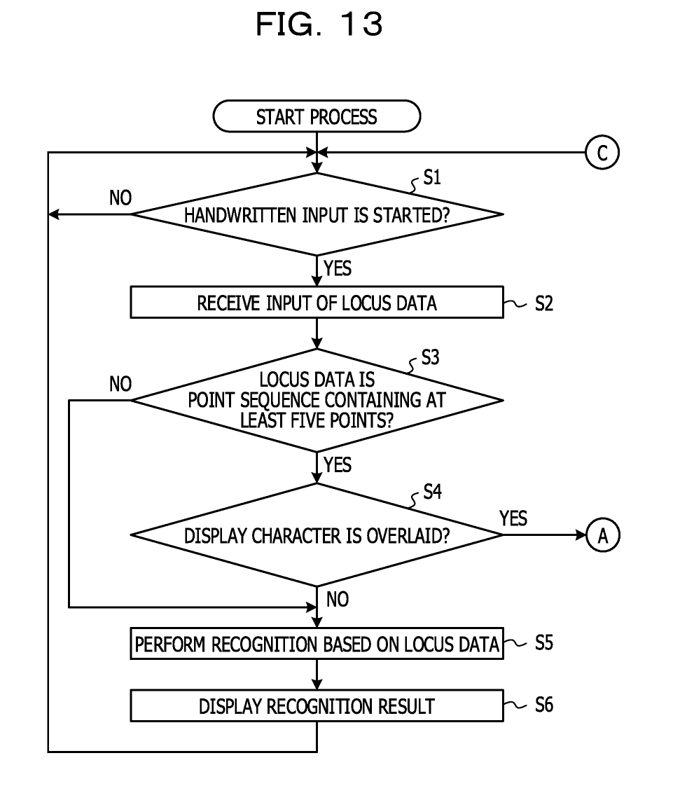

FIGS. 13 to 15 each are a flowchart illustrating an example of a process flow in the embodiment. The control unit 2 determines whether a handwritten input is started (step S1). The input reception unit 11 may determine that the handwritten input is started in response to the detection of pressing operation by the touch screen display 3, for example.

If the result is NO in step S1, the process does not proceed to the next step. If the result is YES in step S1, the input reception unit 11 receives an input of locus data of the handwriting to the touch screen display 3 (step S2).

The locus data is a point sequence, as described above. The first point of the locus data is a point at which the touch screen display 3 detects pressing first. The last point thereof is a point when the touch screen display 3 does not detect any more pressing. Each point in the locus data is detected every certain time interval.

The control unit 2 determines whether the locus data is a point sequence containing at least five points (step S3). This locus data is locus data indicating single-stroke writing. The turnback detection unit 13 detects a turned-back position based on the deceleration forward from the turned-back position and the acceleration rearward from the turned-back position, in the direction of handwriting.

The deceleration at the point forward from the turned-back position is obtained based on the coordinates of the point one before and those of the point two before the point of the turned-back position, and the above-described certain time interval. The acceleration at the point rearward from the turned-back position is obtained based on the coordinates of the point one after and those of the point two after of the point of the turned-back position, and the above-described certain time interval.

Therefore, the locus data has to contain at least five points for obtaining the deceleration forward from the turned-back position and the acceleration rearward from the turned-back position, in the direction of handwriting. When the turnback is detected by using either of the deceleration or the acceleration, determination is made whether the locus data contains at least three points in step S3.

The turned-back position may be detected based on the velocity forward or rearward from the turned-back position in the direction of handwriting.

In a case where the velocity immediately before the turned-back position in the direction of handwriting is a predetermined velocity or greater, a difference in velocity between the turned-back position and the point at which this velocity is detected is large. The turnback in this case is highly likely to be a turnback intended by an operator.

In a case where the velocity immediately behind the turned-back position in the direction of handwriting is a predetermined velocity or greater, a difference in velocity between the turned-back position and the point at which this velocity is detected is large. The turnback in this case is highly likely to be a turnback intended by an operator.

When the turned-back position is detected based on the velocity forward or rearward from the turned-back position in the direction of handwriting, determination is made whether the locus data is a point sequence containing at least two points in step S3.

If the result is NO in step S3, determination on the deletion instruction is not made due to lack of information for detecting the turned-back position by the turnback detection unit 13. If the result is YES in step S3, the control unit 2 determines whether the locus data is overlaid on the display character (step S4). The determination in step S4 may be performed based on the coordinates of each point in the locus data and the coordinates of the display character, for example.

If the result is NO in step S3 or the result is NO in step S4, the recognition unit 12 recognizes a character, a symbol, or the like based on the locus data (step S5). The display control unit 16 displays the recognition result (recognized character, symbol, or the like) on the touch screen display 3 (step S6). The process returns to step S1.

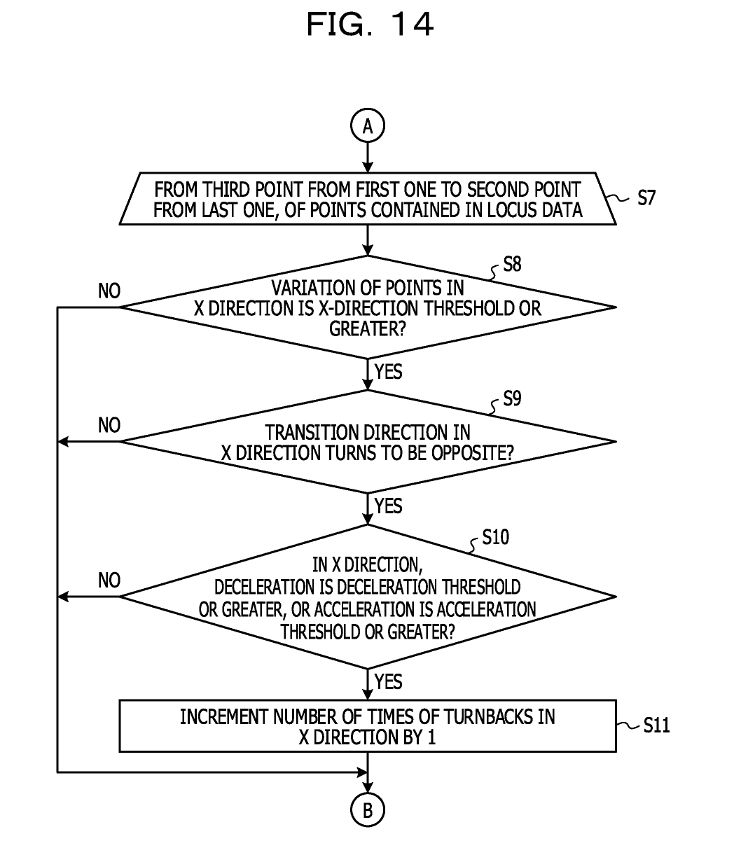

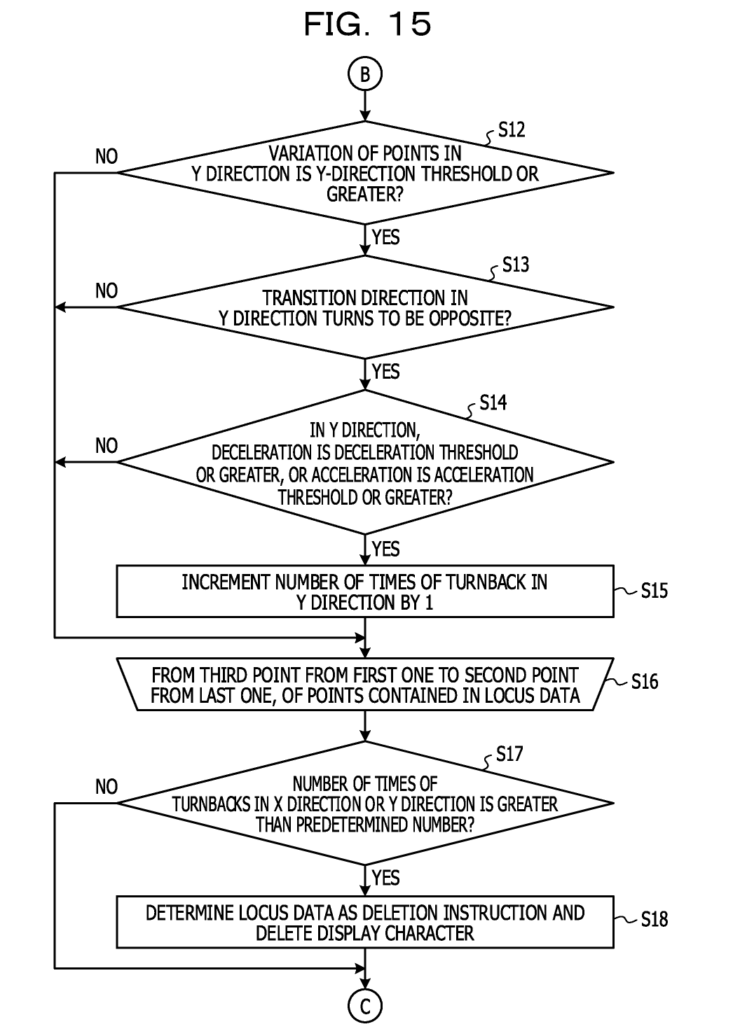

If the result is YES in step S4, the process proceeds to “A”. The process “A” and subsequent processes will be described by referring to FIGS. 14 and 15. The locus data contains at least five points, as described above. Processes of steps S7 to S16 are performed on the points from the third from the first one to the second from the last one, of the points contained in the locus data.

The turnback detection unit 13 determines, with regard to the two continuous points, whether the variation in the X direction is the threshold ε(X) or greater (step S8). If the result is YES in step S8, the turnback detection unit 13 determines whether the direction of handwriting turns to be opposite (step S9). Whether the direction of handwriting turns to be opposite may be determined based on the above-described vector M.

If the result is YES in the step S9, the turnback detection unit 13 detects whether the deceleration in the direction of handwriting (X direction) with respect to the turned-back position is the deceleration threshold or greater, or the acceleration in the direction of handwriting (X direction) with respect to the turned-back position is the acceleration threshold or greater (step S10).

If the result is YES in step S10, an intentional turnback in a handwritten input to the touch screen display 3 is detected. The number-of-times-of-turnback identification unit 14 increments the number of times of turnbacks in the X direction by 1 (step S11). An initial value of the number of times of turnbacks in the X direction is zero.

If the result is NO in step S8, the result is NO in step S9, or the result is NO in step S10, the process of step S11 is not performed. If step S8 is determined as NO, the processes of steps S9 to S11 may be omitted. A process “B” and subsequent processes will be described by referring to the flowchart in FIG. 15.

The turnback detection unit 13 determines, with regard to the two continuous points, whether the variation in the Y direction is the threshold ε(Y) or greater (step S12). If the result is YES in step S12, the turnback detection unit 13 determines whether the writing direction turns to be opposite (step S13).

If the result is YES in step S13, the turnback detection unit 13 detects whether the deceleration in the direction of handwriting (Y direction) with respect to the turned-back position is the deceleration threshold or greater, or the acceleration in the direction of handwriting (Y direction) with respect to the turned-back position is the acceleration threshold or greater (step S14).

If the result is YES in step S14, an intentional turnback in a handwritten input to the touch screen display 3 is detected. The number-of-times-of-turnback identification unit 14 increments the number of times of turnbacks in the Y direction by 1 (step S15). An initial value of the number of times of turnbacks in the Y direction is zero.

If the result is NO in step S12, the result is NO in step S13, or the result is NO in step S14, the process of step S15 is not performed. If step S12 is determined as NO, the processes of steps S13 to S15 may be omitted.

The determination unit 15 determines whether the number of times of turnbacks in the X direction or the Y direction is greater than the predetermined number (step S17). If the result is YES in step S17, the determination result is affirmative. The determination unit 15 determines that the locus data is a deletion instruction in this case.

The display control unit 16 then performs a control to delete the display character overlaid on the locus data. The display character to be deleted is deleted from the touch screen display 3 based on this control (step S18).

If the result is NO in step S17 or the process of step S18 is performed, the process returns to step S1 from “C”.

### MODIFIED EXAMPLE 1

A modified example 1 will now be described. An operator inputs a locus containing multiple turnbacks to the touch screen display 3 when deleting a display character. In the modified example 1, the display control unit 16 performs a control to reduce display density of each of a display character and locus data each time the turnback detection unit 13 detects a turnback.

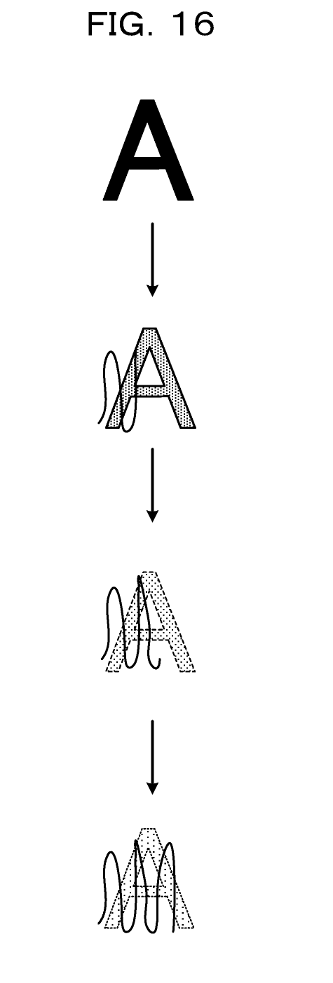

Each time the number of times of turnbacks of locus data that is input over a display character “A” is increased, the display control unit 16 performs a control to reduce the display density of each of the display character “A” and the locus data, as illustrated in an example of FIG. 16. This enables an operator to visually check that the operation of a current input to the touch screen display 3 is a deletion instruction.

As illustrated in the example of FIG. 16, the display density of each of the display character “A” and the locus data that are displayed on the touch screen display 3 is reduced (lowered) stepwise based on the control by the display control unit 16.

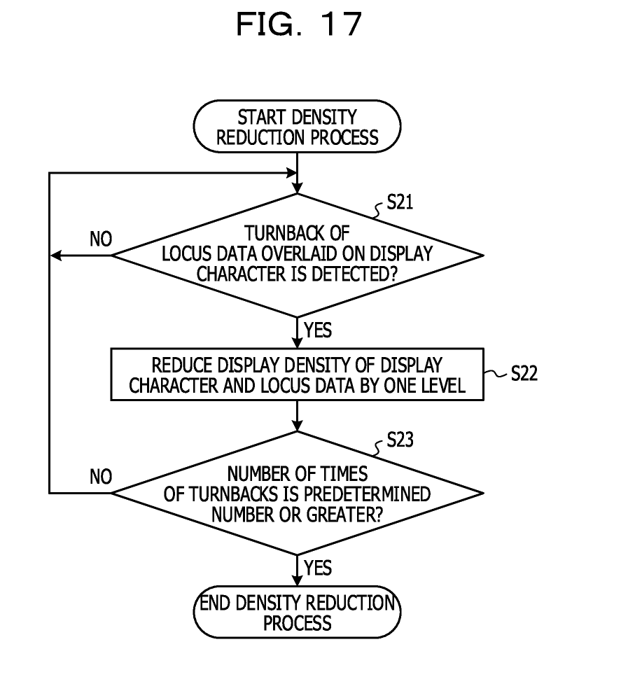

Referring to FIG. 17, a density reduction process of the modified example 1 will be described. Determination is made whether the turnback detection unit 13 detects a turnback of the locus data overlaid on the display character (step S21). Whether the turnback of the locus data overlaid on the display character is detected may be realized by, for example, the processes of steps S9 and S10 described above. If the result is NO in step S21, the process does not proceed to the next step.

If the result is YES in step S21, the display control unit 16 reduces the display density of each of the display character and the locus data by one level (step S22). The determination unit 15 determines whether the number of times of turnbacks is greater than the predetermined number (step S23).

If the result is NO in step S23, the process returns to step S21. If the result is YES in step S23, it is ascertained that the locus data is a deletion instruction, and thus the process ends. The display character overlaid on the locus data in this case is deleted.

### MODIFIED EXAMPLE 2

A modified example 2 will now be described. For example, a case is conceivable where an operator hesitates to delete a display character when inputting a deletion instruction over the display character. In the modified example 2, when the handwritten input for a deletion instruction is paused for a predetermined period (first period) or longer, the determination unit 15 determines that the deletion instruction is canceled. For example, the determination unit 15 may determine that the deletion instruction is canceled when the position indicated by the locus data indicates an identical position for the first period or longer.

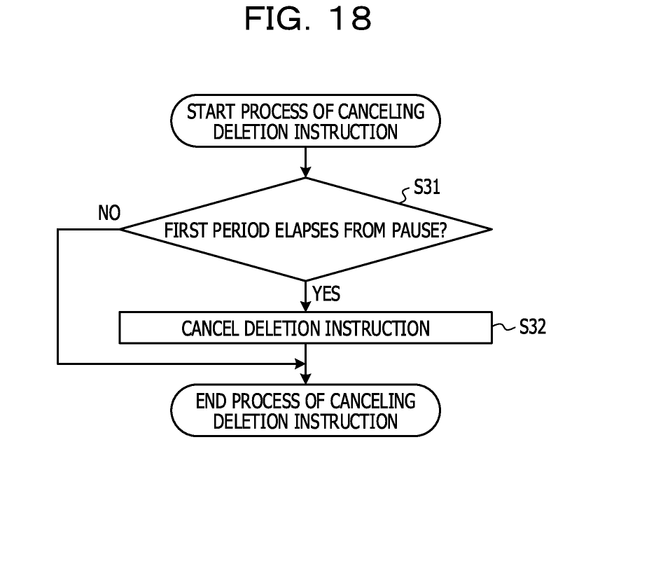

The determination unit 15, as illustrated in an example of the flowchart in FIG. 18, determines whether the position indicated by the locus data stays at the identical position for the first period or longer (step S31). If the result is YES in step S31, the control unit 2 cancels the deletion instruction (step S32). If the result is NO in step S31, the process of step S32 is not performed.

This enables an operator to cancel the deletion instruction when inputting the deletion instruction, which improves the usability for the operator when inputting a deletion instruction by handwriting.

### MODIFIED EXAMPLE 3

A modified example 3 will now be described. In the modified example 1, the display control unit 16 performs a control to reduce the display density of each of the display character and the locus data each time the turnback detection unit 13 detects a turnback of the locus data. Thus, the display density of each of the display character and the locus data that are displayed on the touch screen display 3 is reduced stepwise.

In the modified example 2, the deletion instruction is canceled when the detection is made that the position indicated by the locus data indicates the identical position for the first period or longer.

In the modified example 3, the display control unit 16 performs a control to increase stepwise the display density of each of the display character and the locus data each time a second period elapses from a pause of a handwritten input of a deletion instruction. The display density of each of the display character and the locus data that is reduced stepwise in the modified example 1 is increased stepwise in the modified example 3, for example.

A control to increase stepwise the display density of each of the display character and the locus data is performed while the handwritten input of a deletion instruction is paused. The second period may therefore be a numeral obtained by dividing the first period by the number of levels for increasing the display density.

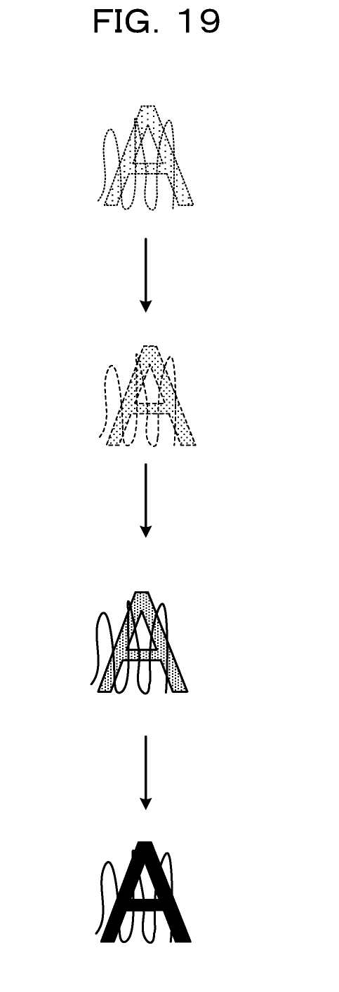

FIG. 19 illustrates an example of changes in the density of the display character and the locus data. As illustrated in the example of FIG. 19, the display density of each of the display character and the locus data that are displayed on the touch screen display 3 is raised stepwise every second period. This enables an operator to visually check cancellation of the deletion instruction.

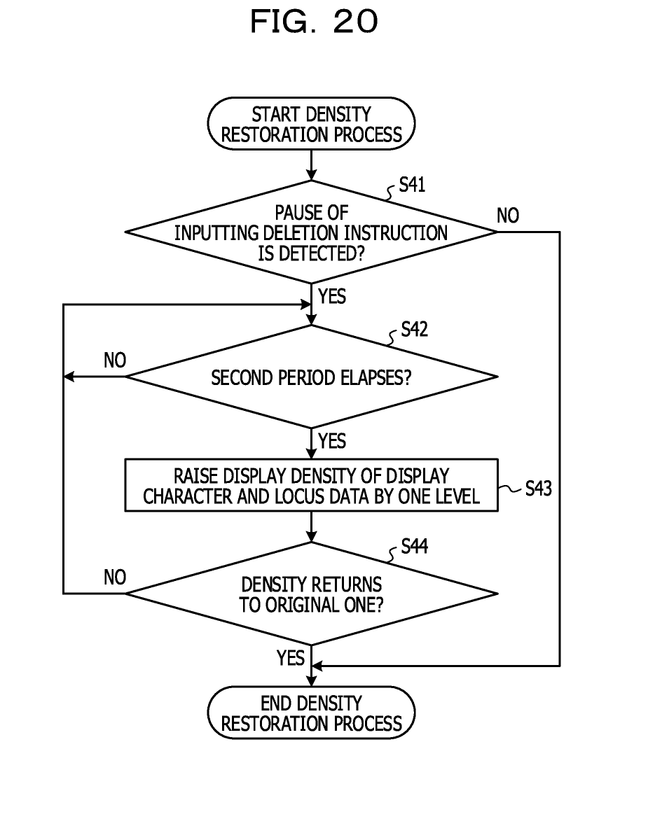

FIG. 20 illustrates an example of a density restoration process in the modified example 3. The determination unit 15, as illustrated in the example of the flowchart in FIG. 20, determines whether the pause of inputting a deletion instruction is detected (step S41). If the result is NO in step S41, the process ends.

If the result is YES in step S41, the determination unit 15 determines whether the second period elapses from the time when the determination of step S41 is determined as YES (step S42). If the result is NO in step S42, the process does not proceed to the next step.

If the result is YES in step S42, the display control unit 16 raises the level of the display density of each of the display character and the locus data by one level (step S43). The determination unit 15 then determines whether the display density of each of the display character and the locus data that are displayed on the touch screen display 3 returns to be the original display density (density before lowered) (step S44).

If the result is NO in step S44, the process returns to step S42. It the result is YES in step S44, the process ends. The display control unit 16 may delete the locus data displayed on the touch screen display 3 in this case.

<Example of Hardware Configuration of Smart Device>

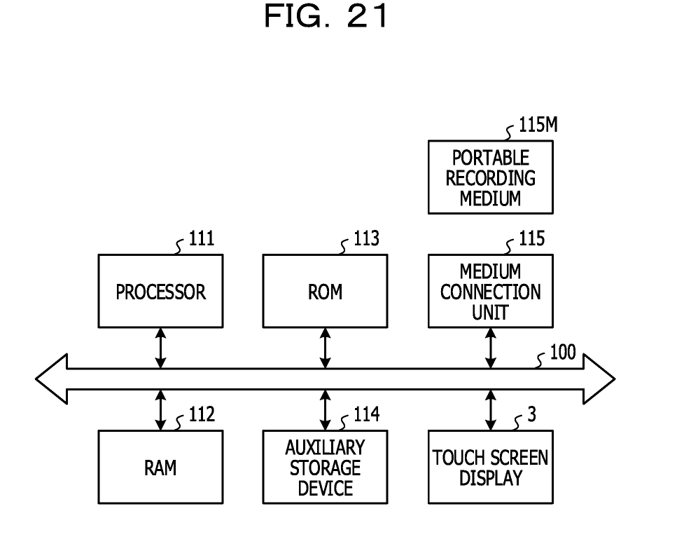

Referring to an example of FIG. 21, an example of a hardware configuration of the smart device 1 will now be described. As depicted in the example of FIG. 21, a processor 111, a random access memory (RAM) 112, and a read only memory (ROM) 113 are connected to a bus 100. Additionally, an auxiliary storage device 114, a medium connection unit 115, and the touch screen display 3 are connected to the bus 100.

The processor 111 executes a program loaded on the RAM 112. An applicable program to be executed may be a determination program for executing the processes in the embodiment.

The ROM 113 is a non-volatile storage device that stores therein the determination program to be loaded on the RAM 112. The auxiliary storage device 114 is a storage device that stores therein various kinds of information, and a hard disk drive and a semiconductor memory, for example, may be applied to the auxiliary storage device 114. The medium connection unit 115 is provided to be connectable to a portable recording medium 115M.

A portable memory (such as a semiconductor memory) may be applied to the portable recording medium 115M. The portable recording medium 115M may store therein the determination program for executing the processes in the embodiment. The above-described control unit 2 may be implemented by the processor 111 executing the determination program that has been given.

The RAM 112, the ROM 113, the auxiliary storage device 114, and the portable recording medium 115M each are an example of a tangible computer-readable storage medium. These tangible storage media are not a transient medium such as a signal carrier wave.

<Others>

The embodiment and the modified examples are not limited to the embodiment described above, and various configurations and embodiments may be adopted without departing from the gist of the embodiment and the modified examples.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
receiving an input of locus data of handwriting;
determining whether at least one of a velocity and acceleration at a position forward or rearward from a turned-back position in a direction of the handwriting in a locus indicated by the locus data satisfies a first criterion based on the input locus data; and
determining whether the received input is a deletion instruction based on whether the first criterion is satisfied.

2. The non-transitory computer-readable storage medium according to claim 1, wherein the process further comprises:
determining whether a number of turned-back positions in the locus satisfies a second criterion based on the input locus data; and
determining that the received input is a deletion instruction when the second criterion is satisfied.

3. The non-transitory computer-readable storage medium according to claim 2, wherein the process further comprises:
incrementing the number of the turned-back positions in response to determining that the first criterion is satisfied.

4. The non-transitory computer-readable storage medium according to claim 1, wherein the process further comprises:
determining that the first criterion is satisfied when a deceleration at the position forward from a turned-back position is equal to or greater than a deceleration threshold and when and the acceleration at the position rearward from the turned-back position is equal to or greater than an acceleration threshold.

5. The non-transitory computer-readable storage medium according to claim 2, wherein the process further comprises:
determining that the second criterion is satisfied when the number of the turned-back positions is greater than a predetermined number; and
in response to a determination that the received input is a deletion instruction, deleting information overlaid on the locus data included in information displayed on a screen of a display device.

6. The non-transitory computer-readable storage medium according to claim 5, wherein
the predetermined number is greater than a greatest number of turned-back positions of a character among characters belonging to a character type recognizable by the computer.

7. The non-transitory computer-readable storage medium according to claim 1, wherein the process further comprises:
detecting a variation between a first position and a second position detected before the first point included in the locus data, each of the first position and the second position being expressed by coordinates in two directions orthogonal to each other; and wherein
the determining whether the first criterion is satisfied is executed when the variation is equal to or greater than a variation threshold.

8. The non-transitory computer-readable storage medium according to claim 1, wherein the process further comprises:
reducing, each time the turned-back position is detected, a display density of information overlaid on the locus data included in information displayed on a screen of a display device.

9. The non-transitory computer-readable storage medium according to claim 1, wherein the process further comprises:
determining that the deletion instruction is canceled when a position indicated by the locus data remains still for a first period or longer than the first period.

10. The non-transitory computer-readable storage medium according to claim 8, wherein the process further comprises:
increasing the display density of the information overlaid on the locus data and the locus data every second period, when the position indicated by the locus data remains still for a first period or longer than the first period.

11. A determination method executed by a computer, the determination method comprising:
receiving an input of locus data of handwriting;
determining whether at least one of a velocity and acceleration at a position forward or rearward from a turned-back position in a direction of the handwriting in a locus indicated by the locus data satisfies a first criterion based on the input locus data; and
determining whether the receiver input is a deletion instruction based on whether the first criterion is satisfied.

12. A determination apparatus comprising:
a memory; and
a processor coupled to the memory and the processor configured to execute a process, the process including:
receiving an input of locus data of handwriting;
determining whether at least one of a velocity and acceleration at a position forward or rearward from a turned-back position in a direction of the handwriting in a locus indicated by the locus data satisfies a first criterion based on the input locus data; and
determining whether the received input is a deletion instruction based on whether the first criterion is satisfied.
